(19) United States
(12) Patent Application Publication
(10) Pub. No.: US 2026/0202206 A1
(43) Pub. Date: Jul. 16, 2026

(54) INFORMATION PROCESSING APPARATUS, INFORMATION PROCESSING SYSTEM, VEHICLE, NON-TRANSITORY COMPUTER READABLE MEDIUM, AND INFORMATION PROCESSING METHOD

(71) Applicant: TOYOTA JIDOSHA KABUSHIKI KAISHA, Toyota-shi (JP)

(72) Inventors: Yu NAGATA, Chofu-shi (JP); Makoto MATSUSHITA, Ichinomiya-shi (JP); Kei KOSAKA, Meguro-ku (JP); Sho MINAGAWA, Nagoya-shi (JP); Haruka FUTATSUBASHI, Chiyoda-ku (JP); Ryota TATSUMI, Nagoya-shi (JP); Yo OKUMURA, Chofu-shi (JP); Toshifumi MICHIDA, Okazaki-shi (JP)

(73) Assignee: TOYOTA JIDOSHA KABUSHIKI KAISHA, Toyota-shi (JP)

(21) Appl. No.: 19/443,593

(22) Filed: Jan. 8, 2026

(30) Foreign Application Priority Data
Jan. 16, 2025 (JP) 2025-006427

(51) Int. Cl. G01C 21/34; G07C 5/04

(52) U.S. Cl. CPC G01C 21/3492; G07C 5/04

(57) ABSTRACT

An information processing apparatus includes a controller that acquires a driver's vehicle speed coefficient obtained by dividing the driver's vehicle speed at a link that a vehicle driven by the driver has traveled, by a predetermined vehicle speed set for the link on a navigation application, estimates, using the driver's vehicle speed coefficient, the driver's vehicle speed for each link, among multiple links included in a route to a destination along which the driver plans to drive the vehicle, and calculates an expected arrival time at which the driver arrives at the destination, from the distance of each link and the driver's vehicle speed estimated for each link.

### CROSS-REFERENCE TO RELATED APPLICATION

This application claims priority to Japanese Patent Application No. 2025-006427 filed on Jan. 16, 2025, the entire contents of which are incorporated herein by reference.

### TECHNICAL FIELD

The present disclosure relates to an information processing apparatus, an information processing system, a vehicle, a non-transitory computer readable medium, and an information processing method.

### BACKGROUND

Technology for calculating arrival times at destinations for vehicles is known. For example, Patent Literature (PTL) 1 discloses technology for improving the prediction accuracy of energy consumption by electric vehicles.

### CITATION LIST

### Patent Literature

PTL 1: JP 6992419 B2

### SUMMARY

When an expected arrival time at a destination is calculated based on vehicle speeds set on a map application, there is a problem that the accuracy of the expected arrival time deteriorates due to the discrepancy between the set vehicle speeds and vehicle speeds at which a user actually drives. Therefore, there is room for improvement in technology for calculating arrival times at destinations for vehicles.

It would be helpful to improve technology related to calculation of arrival times at destinations for vehicles.

An information processing apparatus according to an embodiment of the present disclosure includes a controller configured to:
acquire a driver's vehicle speed measured by a vehicle speed sensor mounted on a vehicle at a link that the vehicle driven by the driver has traveled;
calculate the driver's vehicle speed coefficient by dividing the acquired driver's vehicle speed by a predetermined vehicle speed set for the link on a navigation application;
estimate the driver's vehicle speed for each link, among multiple links included in a route to a destination along which the driver plans to drive the vehicle, by multiplying the driver's vehicle speed coefficient by a predetermined vehicle speed set for each link on the navigation application;
acquire a state of each link detected at each link by a sensor configured to monitor a road;
select one or more links, among the multiple links, according to the acquired state of each link;
calculate time required for the driver to drive the vehicle for each link, by dividing distances of the one or more links by the driver's vehicle speeds estimated for the one or more links, and dividing distances of remaining links by predetermined vehicle speeds set for the remaining links on the navigation application;
calculate an expected arrival time at which the driver arrives at the destination, based on the calculated time required for each link; and
output the calculated expected arrival time as part of screen display or voice guidance of the navigation application.

An information processing apparatus according to an embodiment of the present disclosure includes a controller configured to:
acquire a driver's vehicle speed coefficient obtained by dividing the driver's vehicle speed at a link that a vehicle driven by the driver has traveled, by a predetermined vehicle speed set for the link on a navigation application;
estimate, using the driver's vehicle speed coefficient, the driver's vehicle speed for each link, among multiple links included in a route to a destination along which the driver plans to drive the vehicle; and
calculate an expected arrival time at which the driver arrives at the destination, from a distance of each link and the driver's vehicle speed estimated for each link.

An information processing method according to an embodiment of the present disclosure is an information processing method performed by an information processing apparatus, the information processing method including:
acquiring a driver's vehicle speed coefficient obtained by dividing the driver's vehicle speed at a link that a vehicle driven by the driver has traveled, by a predetermined vehicle speed set for the link on a navigation application;
estimating, using the driver's vehicle speed coefficient, the driver's vehicle speed at each link, among multiple links included in a route to a destination along which the driver plans to drive the vehicle; and
calculating an expected arrival time at which the driver arrives at the destination, from a distance of each link and the driver's vehicle speed estimated for each link.

According to an embodiment of the present disclosure, technology for calculating arrival times at destinations for vehicles is improved.

### BRIEF DESCRIPTION OF THE DRAWINGS

In the accompanying drawings:

FIG. 1 is a block diagram illustrating an example of a schematic configuration of a system according to an embodiment of the present disclosure;

FIG. 2 is a flowchart illustrating an example of operations of the system;

FIG. 3 is a diagram illustrating an example of a route along which a vehicle travels;

FIG. 4 is a diagram explaining calculation of the time required to travel each link; and

FIG. 5 is a table explaining calculation of the time required to travel each link.

### DETAILED DESCRIPTION

### Outline of Embodiment

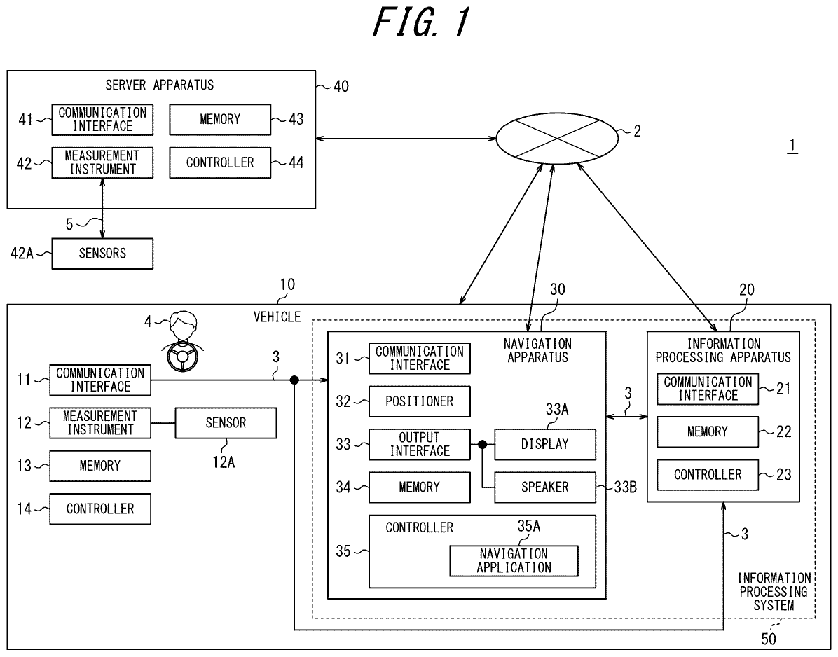

An outline of a system 1 according to an embodiment of the present disclosure will be described with reference to FIG. 1. The system 1 includes a server apparatus 40 and a vehicle 10 equipped with an information processing system 50. The information processing system 50 includes an information processing apparatus 20 and a navigation apparatus 30. The vehicle 10 and the server apparatus 40 are communicably connected to a network 2 including, for example, the Internet, a mobile communication network, and the like. The information processing apparatus 20 and the navigation apparatus 30 may be independently communicably connected to the network 2. In the vehicle 10, the information processing apparatus 20, the navigation apparatus 30, and other apparatuses may be communicably connected via a wired in-vehicle network 3 such as a controller area network (CAN).

The vehicle 10 is an automobile, for example, but is not limited to this and may be any vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these.

The information processing apparatus 20 is a computer mounted on the vehicle 10.

The navigation apparatus 30 is an apparatus that performs positioning of the vehicle 10, display of road maps, route searches, and the like for the purpose of assisting the driving of the vehicle 10.

The server apparatus 40 is a computer operated by a provider that supplies road traffic information. The server apparatus 40 detects the states of roads by sensors 42A, which are installed, for example, on the roadside of the roads to monitor the roads, and transmits the detected states of the roads to the navigation apparatus 30 or the information processing apparatus 20 via the network 2. The server apparatus 40 acquires the states of the roads detected by the sensors 42A via a wired or wireless sensor network 5.

First, an outline of the present embodiment will be described, and details thereof will be described later. The information processing apparatus 20 acquires a driver 4's vehicle speed coefficient obtained by dividing the driver 4's vehicle speed at a link that the vehicle 10 driven by the driver 4 has traveled, by a predetermined vehicle speed set for the link on a navigation application 35A, estimates, using the driver 4′s vehicle speed coefficient, the driver 4's vehicle speed for each link, among multiple links included in a route to a destination along which the driver 4 plans to drive the vehicle 10, and calculates an expected arrival time at which the driver 4 arrives at the destination, from a distance of each link and the driver 4's vehicle speed estimated for each link.

As described above, according to the present embodiment, the vehicle speed at which the driver 4 travels each link, among the multiple links included in the route to the destination, is estimated using the driver 4's vehicle speed coefficient. Therefore, it is possible to calculate the expected arrival time at which the vehicle 10 arrives at the destination, based on vehicle speeds that do not deviate from the driver 4's actual vehicle speeds. Thus, in terms of enhancing the accuracy of calculating the expected arrival time at the destination, technology for calculating arrival times of vehicles at destinations is improved. One or more or all links among the multiple links may be links that the driver 4 has never traveled.

### Configuration of Vehicle

As illustrated in FIG. 1, the vehicle 10 includes a communication interface 11, a measurement instrument 12, a memory 13, a controller 14, the information processing apparatus 20, and the navigation apparatus 30. The configuration of the information processing apparatus 20 and the navigation apparatus 30 will be described later.

The communication interface 11 includes a communication interface that is wirelessly connected to the network 2, and a communication interface that is wired to the in-vehicle network 3. The communication interface connected to the network 2 is compliant with, for example, a mobile communication standard. The communication interface wired to the in-vehicle network 3 is compliant with, for example, CAN. In the present embodiment, the vehicle 10 communicates with the information processing apparatus 20 and the navigation apparatus 30 via the network 2 or the in-vehicle network 3.

The measurement instrument 12 includes a sensor 12A. The sensor 12A is a sensor that measures a vehicle speed while the vehicle 10 is in motion.

The memory 13 includes one or more memories. The memories are, for example, semiconductor memories, magnetic memories, optical memories, or the like, but are not limited to these. The memories included in the memory 13 may each function as, for example, a main memory, an auxiliary memory, or a cache memory. The memory 13 stores any information to be used for operations of the vehicle 10. For example, the memory 13 may store a system program, an application program, and the like. The information stored in the memory 13 may be updated with information acquired from the network 2 via the communication interface 11, for example.

The controller 14 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 14 controls operations of the entire vehicle 10.

### Configuration of Information Processing Apparatus

As illustrated in FIG. 1, the information processing apparatus 20 includes a communication interface 21, a memory 22, and a controller 23.

The communication interface 21 includes at least one communication interface that is connected to the network 2, and a communication interface that is wired to the in-vehicle network 3. The communication interface connected to the network 2 is compliant with, for example, a mobile communication standard or a wireless local area network (LAN) standard. The communication interface wired to the in-vehicle network 3 is compliant with, for example, CAN. In the present embodiment, the information processing apparatus 20 communicates with the vehicle 10 and the navigation apparatus 30 via the network 2 or the in-vehicle network 3. The information processing apparatus 20 also communicates with the server apparatus 40 via the network 2.

The memory 22 includes one or more memories. The memories are, for example, semiconductor memories, magnetic memories, optical memories, or the like, but are not limited to these. The memories included in the memory 22 may each function as, for example, a main memory, an auxiliary memory, or a cache memory. The memory 22 stores any information to be used for operations of the information processing apparatus 20. For example, the memory 22 may store a system program, an application program, and the like. The information stored in the memory 22 may be updated with, for example, information acquired from the network 2 via the communication interface 21.

The controller 23 includes at least one processor, at least one programmable circuit, at least one dedicated circuit, or a combination of these. The controller 23 controls operations of the entire information processing apparatus 20.

### Configuration of Navigation Apparatus

As illustrated in FIG. 1, the navigation apparatus 30 includes a communication interface 31, a positioner 32, an output interface 33, a memory 34, and a controller 35.

The communication interface 31 includes at least one communication interface that is connected to the network 2, and a communication interface that is wired to the in-vehicle network 3. The communication interface connected to the network 2 is compliant with, for example, a mobile communication standard or a wireless LAN standard. The communication interface wired to the in-vehicle network 3 is compliant with, for example, CAN. In the present embodiment, the navigation apparatus 30 communicates with the vehicle 10 and the information processing apparatus 20 via the network 2 or the in-vehicle network 3. The navigation apparatus 30 also communicates with the server apparatus 40 via the network 2.

The positioner 32 includes one or more apparatuses that acquire position information on the vehicle 10. Specifically, the positioner 32 includes a receiver corresponding to the Global Positioning System (GPS), for example, but is not limited to this and may include a receiver corresponding to any satellite positioning system.

The output interface 33 includes a display 33A. The display 33A is a display device, such as a liquid crystal display (LCD) or an organic electro luminescent (EL) display, capable of displaying various screens. The output interface 33 also includes a speaker 33B.

The memory 34 includes one or more memories. The memories are, for example, semiconductor memories, magnetic memories, optical memories, or the like, but are not limited to these. The memories included in the memory 34 may each function as, for example, a main memory, an auxiliary memory, or a cache memory. The memory 34 stores any information used for operations of the navigation apparatus 30. For example, the memory 34 may store application programs including a system program and a navigation application 35A, map information, and the like. The information stored in the memory 34 may be updated with, for example, information acquired from the network 2 via the communication interface 31.

The controller 35 includes at least one processor, at least one programmable circuit, at least one dedicated circuit, or a combination of these. The controller 35 activates the navigation application 35A to search for a route from a starting point to a destination, and calculates an expected arrival time at the destination. The controller 35 controls operations of the entire navigation apparatus 30.

### Configuration of Server Apparatus

As illustrated in FIG. 1, the server apparatus 40 includes a communication interface 41, a measurement instrument 42, a memory 43, and a controller 44.

The communication interface 41 includes at least one communication interface for connecting to the network 2. The communication interface connected to the network 2 is compliant with, for example, a mobile communication standard, a wired LAN standard, or a wireless LAN standard. In the present embodiment, the server apparatus 40 communicates with the information processing apparatus 20 and the navigation apparatus 30 via the network 2.

The measurement instrument 42 includes the sensors 42A. The sensors 42A include one or more sensors that are installed, for example, on the roadsides of roads to monitor the states of the roads. Specifically, the one or more sensors may include various weather sensors that observe wind direction, wind speed, temperature, rainfall, humidity, atmospheric pressure, illumination, ultraviolet light, and the like, and video cameras that capture images of the roads. The measurement instrument 42 communicates with the one or more sensors via the wired or wireless sensor network 5. However, the one or more sensors are not limited to these.

The memory 43 includes one or more memories. The memories are, for example, semiconductor memories, magnetic memories, optical memories, or the like, but are not limited to these. The memories included in the memory 43 may each function as, for example, a main memory, an auxiliary memory, or a cache memory. The memory 43 stores any information used for operations of the server apparatus 40. For example, the memory 43 may store a system program, an application program, the types of roads (national roads, prefectural roads, and city roads) laid in a predetermined area, the number of lanes for each link among multiple links included in those roads, and the like. The information stored in the memory 43 may be updated with, for example, information acquired from the network 2 via the communication interface 41.

The controller 44 includes at least one processor, at least one programmable circuit, at least one dedicated circuit, or a combination of these. The controller 44 controls operations of the entire server apparatus 40.

### Flow of Operations of Information Processing Apparatus

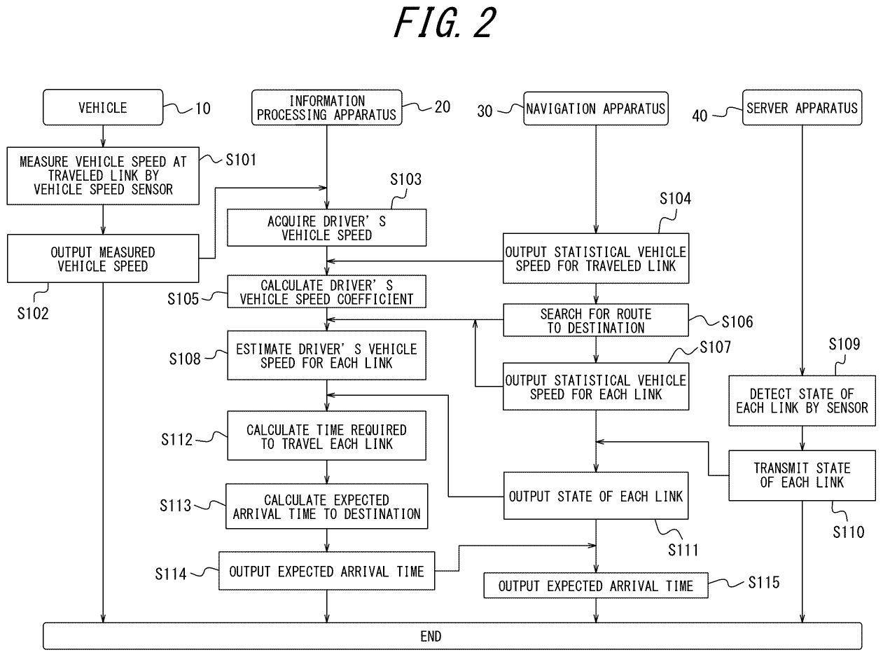

FIG. 2 is a flowchart illustrating an example of operations of the system 1. With reference to FIG. 2, operations of the system 1 and the information processing apparatus 20 according to the present embodiment will be described.

S101: The controller 14 of the vehicle 10 measures a driver 4's vehicle speed Sx at a link Lx that the vehicle 10 driven by the driver 4 has traveled, using the sensor 12A mounted on the vehicle 10.

The driver 4's vehicle speed Sx may be an average speed Sx(av) while traveling on the link Lx. The controller 14 measures vehicle speeds Sx multiple times using the sensor 12A while the vehicle 10 is traveling on the link Lx, and calculates the average speed Sx(av) of the measured multiple vehicle speeds Sx.

S102: The controller 14 outputs the measured driver 4's vehicle speed Sx to the information processing apparatus 20.

S103: The controller 23 of the information processing apparatus 20 acquires the driver 4's vehicle speed Sx.

The link Lx is a road section in which no congestion occurred while the vehicle 10 was traveling. In the present embodiment, the controller 23 determines a certain road section as a link at which congestion is occurring when the road section is a link at which a vehicle queue traveling at a low speed, which is a speed equal to or less than a specified vehicle speed, or a vehicle queue repeatedly stopping and starting continues for a specified length or more and for specified time or more. A vehicle speed measured on such a link at which congestion has occurred does not reflect the driver 4′s characteristics, and is hard to say to be the driver 4's actual vehicle speed. Therefore, the controller 23 acquires a vehicle speed measured on a road section at which no congestion has occurred as the driver 4's vehicle speed Sx.

The specified vehicle speed, specified length, and specified time are defined by an operator managing and operating roads, or the like. For example, congestion on highways managed by Central Nippon Expressway Company Limited, East Nippon Expressway Company Limited, and West Nippon Expressway Company Limited is defined as a state in which a vehicle queue traveling at a low speed of 40 km/h or less, or a vehicle queue repeatedly stopping and starting continues for 1 km or more and for 15 minutes or more. However, the definition of congestion is not limited to this.

The link Lx is a road section with two or more lanes. The driver 4 is easily influenced by the vehicle speed of a driver of a vehicle traveling ahead while traveling on a link with one lane. Therefore, the controller 23 acquires a vehicle speed measured on a road section with two or more lanes, in addition to being a road section in which no congestion has occurred, as the driver 4's vehicle speed Sx.

Upon acquiring the driver 4's vehicle speed Sx, the controller 23 requests the navigation apparatus 30 to transmit a predetermined vehicle speed set for the link Lx on the navigation application 35A.

In the present embodiment, the predetermined vehicle speed set for the link Lx is assumed to be a statistical vehicle speed Tx, but is not limited to this. The statistical vehicle speed Tx is statistical data on vehicle speeds of multiple vehicles that have traveled the link Lx.

S104: The controller 35 of the navigation apparatus 30 outputs, to the information processing apparatus 20, the statistical vehicle speed Tx set for the link Lx on the navigation application 35A.

S105: The controller 23 calculates the driver 4's vehicle speed coefficient α by dividing the acquired driver 4's vehicle speed Sx by the statistical vehicle speed Tx set for the link Lx on the navigation application 35A, as indicated by the following equation (1).

$$Vehicle speed coefficient α = Sx ( km / h ) / Tx ( km / h ) \qquad ( 1 )$$

The driver 4's vehicle speed coefficient α may be a coefficient obtained for each type of links Lx that the vehicle 10 driven by the driver 4 has traveled. The types of links Lx refer to the distinction between, for example, highways, general roads, and the like. This allows for calculation of the driver 4's vehicle speed coefficient α for each of links Lx with different speed limits (legal speeds). However, the types of links Lx are not limited to these and may be the distinction between national roads, prefectural roads, city roads, and the like. In S108 described later, the controller 23 preferably estimates the driver 4's vehicle speed for each link using, as the driver 4's vehicle speed coefficient α, a coefficient according to the type of each link. This improves the accuracy with which the controller 23 calculates an expected arrival time at a destination.

The driver 4's vehicle speed coefficient α may be a coefficient obtained for each rank of congestion degree β of the link Lx that the vehicle 10 driven by the driver 4 has traveled. As indicated in the following equation (2), the congestion degree β is an index represented by the ratio of traffic volume measured at each of the link Lx that the vehicle 10 driven by the driver 4 has traveled and each link described later, to traffic capacity set for the corresponding link. The traffic capacity is the maximum number of vehicles that can pass through a single lane or a cross-section of a road in one hour. The traffic volume is the number of vehicles actually passed through that cross-section in one hour, that has been measured by a video camera included in a sensor 42A installed on the roadside of a road.

$$Congestion degree β = Traffic volume / Traffic capacity \qquad ( 2 )$$

The controller 23 classifies the congestion degree β into four ranks, for example, less than 1.0, 1.0 to 1.25, 1.25 to 1.75, and 1.75 or more, and calculates the driver 4's vehicle speed coefficient α for each classified rank of the congestion degree β. In S108 described later, the controller 23 preferably estimates the driver 4's vehicle speed for each link using, as the driver 4's vehicle speed coefficient α, a coefficient according to the rank of congestion degree β of each link. This improves the accuracy with which the controller 23 calculates an expected arrival time at a destination.

The driver 4's vehicle speed coefficient α may be a coefficient obtained for each number of lanes of links Lx that the vehicle 10 driven by the driver 4 has traveled. The more lanes a link has, the less the driver 4's vehicle speed is affected by the speeds of vehicles ahead, making it possible to accurately calculate the driver 4's vehicle speed coefficient α. In S108 described later, the controller 23 preferably estimates the driver 4's vehicle speed for each link using, as the driver 4's vehicle speed coefficient α, a coefficient according to the number of lanes of each link. This improves the accuracy with which the controller 23 calculates an expected arrival time at a destination.

The driver 4's vehicle speed coefficient α may be a coefficient obtained for each season (for example, each of four seasons of spring, summer, autumn, and winter) in which the vehicle 10 driven by the driver 4 has traveled the link Lx. When a link that the driver 4 travels leads to a tourist destination that gets crowded with tourists in each season, seasonal differences may affect the driver 4's vehicle speed. In S108 described later, the controller 23 preferably estimates the driver 4's vehicle speed for each link using, as the driver 4's vehicle speed coefficient α, a coefficient for each link according to a season in which the driver 4 plans to drive the vehicle 10. This improves the accuracy with which the controller 23 calculates an expected arrival time at a destination.

The driver 4's vehicle speed coefficient α may be a coefficient obtained for each weather condition in which the vehicle 10 driven by the driver 4 has traveled the link Lx. When the weather condition in which the driver 4 has traveled the link is, for example, sunny, rainy (light or heavy), stormy, or snowy, the differences in weather condition may affect the driver 4's vehicle speed. In S108 described later, the controller 23 preferably estimates the driver 4's vehicle speed for each link using, as the driver 4's vehicle speed coefficient α, a coefficient of each link according to a weather condition in which the driver 4 plans to drive the vehicle 10. This improves the accuracy with which the controller 23 calculates an expected arrival time at a destination.

S106: The controller 35 searches for a route r to a destination Pd along which the driver 4 plans to drive the vehicle 10, and outputs the searched route r to the information processing apparatus 20.

When a destination Pd is input and a route search icon is selected on a screen of the navigation application 35A, the controller 35 searches for a route r to the destination Pd. The controller 35 divides the detected route r into multiple links and outputs information on each link Li (i=1 to n) of the divided multiple links, along with the route r, to the information processing apparatus 20.

S107: The controller 35 outputs a predetermined vehicle speed set for each link Li of the multiple links included in the route r to the information processing apparatus 20.

In the present embodiment, the predetermined vehicle speed set for each link Li is assumed to be a statistical vehicle speed Ti (i=1 to n), but is not limited to this. The statistical vehicle speed Ti is statistical data on vehicle speeds of multiple vehicles that have traveled each link Li of the multiple links.

S108: The controller 23 estimates the driver 4's vehicle speed Si (i=1 to n) for each link Li by multiplying the driver 4's vehicle speed coefficient α by the statistical vehicle speed Ti set for each link Li of the multiple links included in the route r to the destination Pd, along which the driver 4 plans to drive the vehicle 10, on the navigation application 35A.

The driver 4's vehicle speed Si estimated by the controller 23 may be an average vehicle speed Si(av) while traveling each link Li.

S109: The controller 44 of the server apparatus 40 detects the state of each link Li by a sensor 42A that monitors a road.

Upon acquiring the information on each link Li of the multiple links, along with the route r to the destination Pd, the controller 23 requests the navigation apparatus 30 to obtain, from the server apparatus 40, the state of each link Li detected by the sensor 42A.

The state of each link Li is information such as the presence or absence of congestion, the number of lanes of each link Li, and the like detected from images captured by a video camera included in the sensor 42A that monitors the road, but is not limited to these.

S110: The controller 44 transmits the state of each link Li detected by the sensor 42A to the navigation apparatus 30.

The controller 35 may display the state of each link Li received from the server apparatus 40 on the navigation application 35A, along with the route r and the information on each link Li of the multiple links.

S111: The controller 35 outputs, to the information processing apparatus 20, the state of each link Li acquired from the server apparatus 40.

S112: The controller 23 calculates the time required for the driver 4 to drive the vehicle 10 for each link Li from the distance Di (i=1 to n) of each link Li and the driver 4's vehicle speed Si for each link Li estimated in S108.

S113: The controller 23 calculates an expected arrival time td for the driver 4 to arrive at the destination Pd based on the time required for each link Li.

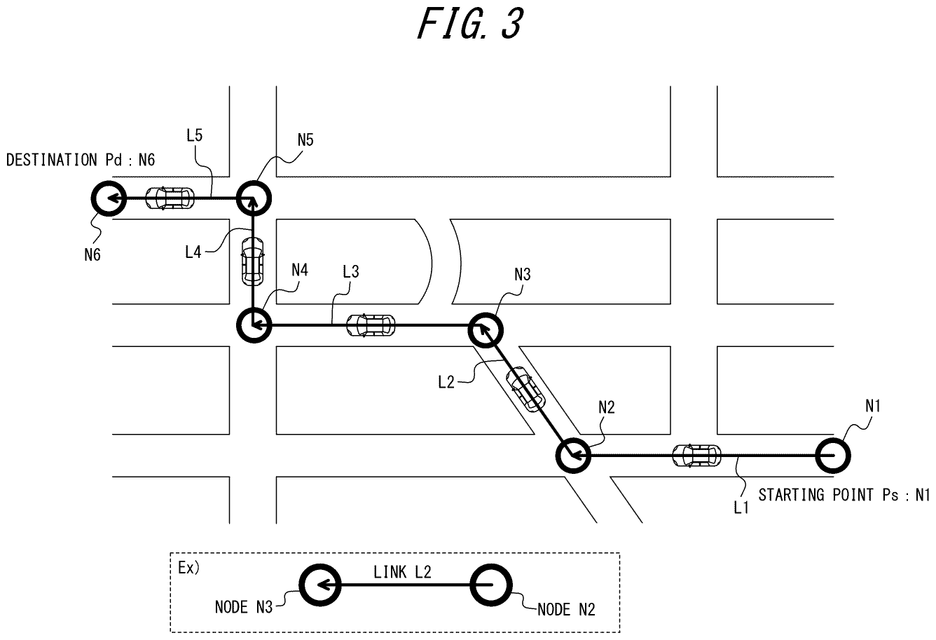

FIG. 3 is a diagram illustrating an example of the travel route r along which the vehicle 10 travels. In the example illustrated in FIG. 3, the route r from the starting point Ps to the destination Pd includes five links of L1, L2, L3, L4, and L5. As illustrated in FIG. 3, a link is a road section between two nodes Ni. As illustrated in FIG. 3, for example, a link L2 is a road section between nodes N2 and N3.

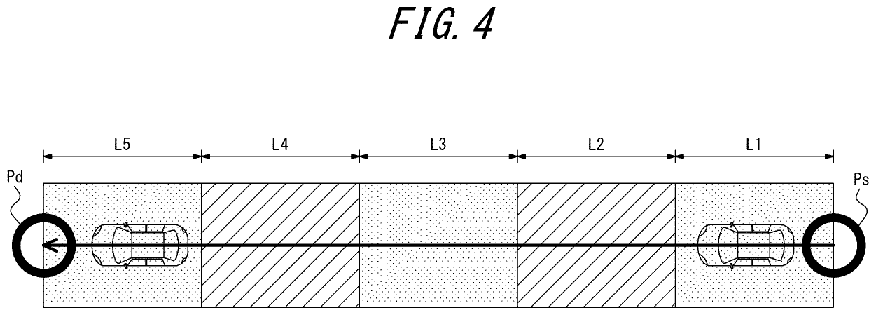

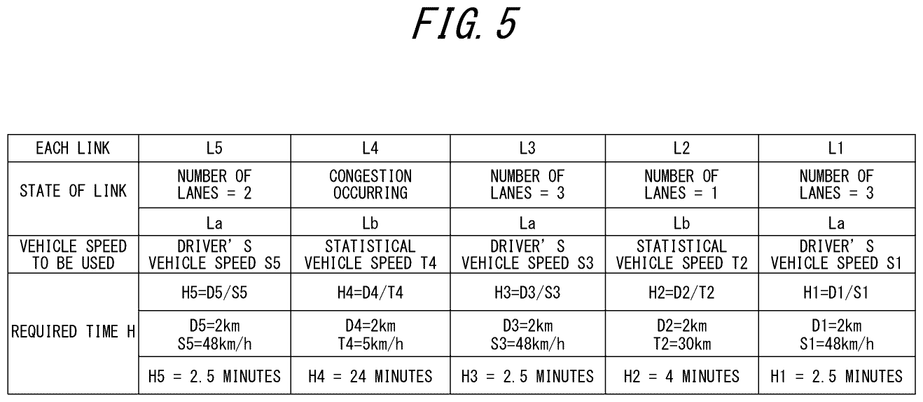

The controller 23 acquires the state of each link Li via the navigation apparatus 30. FIG. 4 and FIG. 5 are a diagram and a table explaining calculation of the time required to travel each link Li. The driver 4 drives the vehicle 10 along the route r from the starting point Ps to the destination Pd as illustrated in FIG. 4. Assumed that the controller 23 has acquired the states of the links indicating that, among the five links L1, L2, L3, L4, and L5 included in the route r, the link L2 has one lane and congestion is occurring at the link L4. The controller 23 classifies the five links into one or more links (hereinafter referred to as links La) and the remaining links (hereinafter referred to as links Lb) according to the acquired state of each of the five links. The controller 23 calculates an expected arrival time td for the driver 4 to arrive at the destination Pd using the following procedure (1) to (4).

The controller 23 selects at least links at which no congestion is occurring as links La, among the multiple links. In this example, the controller 23 selects a link at which congestion is occurring as a link Lb. However, whether to select a link at which congestion is occurring as a link La or a link Lb may be changed depending on the number of lanes. The controller 23 further selects at least links with two or more lanes as links La, among the multiple links. In this example, the controller 23 selects a link with one lane as a link Lb. However, whether to select a link with one lane as a link La or a link Lb may be changed depending on the presence or absence of congestion. The controller 23 determines, among the multiple links, a link at which a vehicle queue traveling at a low speed that is a speed equal to or less than a specified vehicle speed or a vehicle queue repeatedly stopping and starting continues for a specified length or more and for specified time or more, as the link at which congestion is occurring.
(1) The controller 23 calculates the time Hi required for the driver 4 to drive the vehicle 10 by dividing the distance Di of each link La, among the multiple links, by the estimated driver 4's vehicle speed Si for that link La. In FIG. 4 and FIG. 5, the links La include the links L1, L3, and L5. The distance D1 of the link L1 is 2 km and the driver 4's vehicle speed S4 is 48 km/h, so the time H1 required for the driver 4 to travel the link L1 is calculated to be 2.5 minutes. In the same manner, the time H3 required for the driver 4 to travel the link L3 is calculated to be 2.5 minutes, and the time H5 required for the driver 4 to travel the link L5 is also calculated to be 2.5 minutes.
(2) The controller 23 calculates the time Hi required for the driver 4 to drive the vehicle 10 for each of the links Lb, among the multiple links, by dividing the distance Di of the link Lb by the statistical vehicle speed Ti for the link Lb on the navigation application 35A. In FIG. 4 and FIG. 5, the controller 23 has selected the link L2 as a link Lb, because link L2 is a link with one lane. The controller 23 has also selected the link L4 as a link Lb, because congestion is occurring at the link L4. The distance D2 of the link L2 is 2 km and a statistical vehicle speed T2 is 30 km/h, so the time H2 required for the driver 4 to travel the link L2 is calculated to be 4 minutes. In the same manner, the distance D4 of the congested link L4 is 2 km and a statistical vehicle speed T4 is 5 km/h, so the time H4 required for the driver 4 to travel the link L4 is calculated to be 24 minutes.
(3) The controller 23 calculates the total time Ht required for the driver 4 to travel to the destination Pd by adding the calculated times H1, H3, and H5 required for the respective links La and the times H2 and H4 required for the respective links Lb. The total required time Ht is calculated to be 35.5 minutes by adding the times H1, H2, H3, H4, and H5 required for the respective links Li.
(4) The controller 23 calculates an expected arrival time td at which the driver 4 arrives at the destination Pd based on a departure time ts from the starting point Ps and the total required time Ht calculated in (3). For example, when the departure time ts is 13:00, the expected arrival time td is calculated to be 13:35:30.

S114: The controller 23 outputs the calculated expected arrival time to the navigation apparatus 30.

S115: The controller 35 outputs the calculated expected arrival time td as part of screen display or voice guidance of the navigation application 35A.

As described above, the information processing apparatus 20 according to the present embodiment acquires a driver 4's vehicle speed coefficient α obtained by dividing the driver 4's vehicle speed Sx at a link Lx that the vehicle 10 driven by the driver 4 has traveled, by a predetermined vehicle speed set for the link Lx on the navigation application 35A, estimates, using the driver 4's vehicle speed coefficient α, the driver 4's vehicle speed Si for each link Li, among multiple links included in a route r to a destination Pd along which the driver 4 plans to drive the vehicle 10, and calculates an expected arrival time td at which the driver 4 arrives at the destination Pd, from the distance Di of each link Li and the driver 4's vehicle speed Si estimated for each link Li.

According to such a configuration, the vehicle speed Si at which the driver 4 travels each link Li, among the multiple links included in the route r to the destination Pd, is estimated using the driver 4's vehicle speed coefficient α. Therefore, it is possible to calculate the expected arrival time td at which the vehicle 10 arrives at the destination Pd, based on vehicle speeds that do not deviate from the driver 4's actual vehicle speeds. Thus, in terms of enhancing the accuracy of calculating the expected arrival time td at the destination Pd, technology for calculating arrival times of vehicles at destinations is improved. One or more or all links among the multiple links may be links that the driver 4 has never traveled.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, the navigation apparatus 30 mounted on the vehicle 10 may be equipped with some or all of the components of the information processing apparatus 20.

In the above-described embodiment, for example, the statistical vehicle speed is used as the predetermined vehicle speed for each link. However, the predetermined vehicle speed may be a vehicle speed uniquely set for each link by the manufacturer of the navigation apparatus 30 or the developer of the navigation application.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

### Appendix 1

An information processing apparatus comprising a controller configured to:
acquire a driver's vehicle speed measured by a vehicle speed sensor mounted on a vehicle at a link that the vehicle driven by the driver has traveled;
calculate the driver's vehicle speed coefficient by dividing the acquired driver's vehicle speed by a predetermined vehicle speed set for the link on a navigation application;
estimate the driver's vehicle speed for each link, among multiple links included in a route to a destination along which the driver plans to drive the vehicle, by multiplying the driver's vehicle speed coefficient by a predetermined vehicle speed set for each link on the navigation application;
acquire a state of each link detected at each link by a sensor configured to monitor a road;
select one or more links, among the multiple links, according to the acquired state of each link;
calculate time required for the driver to drive the vehicle for each link, by dividing distances of the one or more links by the driver's vehicle speeds estimated for the one or more links, and dividing distances of remaining links by predetermined vehicle speeds set for the remaining links on the navigation application;
calculate an expected arrival time at which the driver arrives at the destination, based on the calculated time required for each link; and
output the calculated expected arrival time as part of screen display or voice guidance of the navigation application.

### Appendix 2

An information processing apparatus comprising a controller configured to:
acquire a driver's vehicle speed coefficient obtained by dividing the driver's vehicle speed at a link that a vehicle driven by the driver has traveled, by a predetermined vehicle speed set for the link on a navigation application;
estimate, using the driver's vehicle speed coefficient, the driver's vehicle speed for each link, among multiple links included in a route to a destination along which the driver plans to drive the vehicle; and
calculate an expected arrival time at which the driver arrives at the destination, from a distance of each link and the driver's vehicle speed estimated for each link.

### Appendix 3

The information processing apparatus according to appendix 2, wherein the controller is configured to:
calculate time required for the driver to drive the vehicle for each link, by dividing distances of one or more links, among the multiple links, by the driver's vehicle speeds estimated for the one or more links, and dividing distances of remaining links by predetermined vehicle speeds set for the remaining links on the navigation application; and
calculate the expected arrival time based on the calculated time required for each link.

### Appendix 4

The information processing apparatus according to appendix 3, wherein the controller is configured to select, among the multiple links, at least a link at which no congestion is occurring as the one or more links.

### Appendix 5

The information processing apparatus according to appendix 4, wherein the controller is configured to determine, among the multiple links, a link at which a vehicle queue traveling at a low speed that is a speed equal to or less than a specified vehicle speed or a vehicle queue repeatedly stopping and starting continues for a specified length or more and for specified time or more, as a link at which congestion is occurring.

### Appendix 6

The information processing apparatus according to any one of appendices 3 to 5, wherein the controller is configured to select, among the multiple links, at least a link with two or more lanes as the one or more links.

### Appendix 7

The information processing apparatus according to any one of appendices 2 to 6, wherein the link that the vehicle driven by the driver has traveled is a road section in which no congestion has occurred during the vehicle's travel.

### Appendix 8

The information processing apparatus according to any one of appendices 2 to 7, wherein the link that the vehicle driven by the driver has traveled is a road section with two or more lanes.

### Appendix 9

The information processing apparatus according to any one of appendices 2 to 8, wherein
the driver's vehicle speed coefficient is a coefficient obtained for each type of links that the vehicle driven by the driver has traveled, and
the controller is configured to estimate the driver's vehicle speed for each link using, as the driver's vehicle speed coefficient, a coefficient according to a type of each link.

### Appendix 10

The information processing apparatus according to any one of appendices 2 to 9, wherein
the driver's vehicle speed coefficient is a coefficient obtained for each rank of congestion degree of the link that the vehicle driven by the driver has traveled, and
the controller is configured to estimate the driver's vehicle speed for each link using, as the driver's vehicle speed coefficient, a coefficient according to a rank of congestion degree of each link.

### Appendix 11

The information processing apparatus according to appendix 10, wherein the congestion degree is an index represented by a ratio of traffic volume measured at each of the link that the vehicle driven by the driver has traveled and the multiple links, to traffic capacity set for a corresponding link.

### Appendix 12

The information processing apparatus according to any one of appendices 2 to 11, wherein
the driver's vehicle speed coefficient is a coefficient obtained for each number of lanes of links that the vehicle driven by the driver has traveled, and
the controller is configured to estimate the driver's vehicle speed for each link using, as the driver's vehicle speed coefficient, a coefficient according to a number of lanes of each link.

### Appendix 13

The information processing apparatus according to any one of appendices 2 to 12, wherein
the driver's vehicle speed coefficient is a coefficient obtained for each season in which the vehicle driven by the driver has traveled the link, and
the controller is configured to estimate the driver's vehicle speed for each link using, as the driver's vehicle speed coefficient, a coefficient for each link according to a season in which the driver plans to drive the vehicle.

### Appendix 14

The information processing apparatus according to any one of appendices 2 to 13, wherein
the driver's vehicle speed coefficient is a coefficient obtained for each weather condition in which the vehicle driven by the driver has traveled the link, and
the controller is configured to estimate the driver's vehicle speed for each link using, as the driver's vehicle speed coefficient, a coefficient for each link according to a weather condition in which the driver plans to drive the vehicle.

### Appendix 15

The information processing apparatus according to any one of appendices 2 to 14, wherein the controller is configured to estimate the driver's vehicle speed for each link by multiplying the driver's vehicle speed coefficient by a predetermined vehicle speed set for each link on the navigation application.

### Appendix 16

The information processing apparatus according to any one of appendices 2 to 15, wherein the driver's vehicle speed at the link that the vehicle driven by the driver has traveled and the driver's vehicle speed estimated for each link by the controller are each an average speed.

### Appendix 17

An information processing system comprising:
the information processing apparatus according to any one of appendices 2 to 16; and
a navigation apparatus on which the navigation application operates.

### Appendix 18

A vehicle comprising the information processing system according to appendix 17.

### Appendix 19

A non-transitory computer readable medium storing a program configured to cause a computer to function as the information processing apparatus according to any one of appendices 2 to 16.

### Appendix 20

An information processing method performed by an information processing apparatus, the information processing method comprising:
acquiring a driver's vehicle speed coefficient obtained by dividing the driver's vehicle speed at a link that a vehicle driven by the driver has traveled, by a predetermined vehicle speed set for the link on a navigation application;
estimating, using the driver's vehicle speed coefficient, the driver's vehicle speed at each link, among multiple links included in a route to a destination along which the driver plans to drive the vehicle; and
calculating an expected arrival time at which the driver arrives at the destination, from a distance of each link and the driver's vehicle speed estimated for each link.

1. An information processing apparatus comprising a controller configured to:
acquire a driver's vehicle speed measured by a vehicle speed sensor mounted on a vehicle at a link that the vehicle driven by the driver has traveled;
calculate the driver's vehicle speed coefficient by dividing the acquired driver's vehicle speed by a predetermined vehicle speed set for the link on a navigation application;
estimate the driver's vehicle speed for each link, among multiple links included in a route to a destination along which the driver plans to drive the vehicle, by multiplying the driver's vehicle speed coefficient by a predetermined vehicle speed set for each link on the navigation application;
acquire a state of each link detected at each link by a sensor configured to monitor a road;
select one or more links, among the multiple links, according to the acquired state of each link;
calculate time required for the driver to drive the vehicle for each link, by dividing distances of the one or more links by the driver's vehicle speeds estimated for the one or more links, and dividing distances of remaining links by predetermined vehicle speeds set for the remaining links on the navigation application;
calculate an expected arrival time at which the driver arrives at the destination, based on the calculated time required for each link; and
output the calculated expected arrival time as part of screen display or voice guidance of the navigation application.

2. An information processing apparatus comprising a controller configured to:
acquire a driver's vehicle speed coefficient obtained by dividing the driver's vehicle speed at a link that a vehicle driven by the driver has traveled, by a predetermined vehicle speed set for the link on a navigation application;
estimate, using the driver's vehicle speed coefficient, the driver's vehicle speed for each link, among multiple links included in a route to a destination along which the driver plans to drive the vehicle; and
calculate an expected arrival time at which the driver arrives at the destination, from a distance of each link and the driver's vehicle speed estimated for each link.

3. The information processing apparatus according to claim 2, wherein the controller is configured to:
calculate time required for the driver to drive the vehicle for each link, by dividing distances of one or more links, among the multiple links, by the driver's vehicle speeds estimated for the one or more links, and dividing distances of remaining links by predetermined vehicle speeds set for the remaining links on the navigation application; and
calculate the expected arrival time based on the calculated time required for each link.

4. The information processing apparatus according to claim 3, wherein the controller is configured to select, among the multiple links, at least a link at which no congestion is occurring as the one or more links.

5. The information processing apparatus according to claim 4, wherein the controller is configured to determine, among the multiple links, a link at which a vehicle queue traveling at a low speed that is a speed equal to or less than a specified vehicle speed or a vehicle queue repeatedly stopping and starting continues for a specified length or more and for specified time or more, as a link at which congestion is occurring.

6. The information processing apparatus according to claim 3, wherein the controller is configured to select, among the multiple links, at least a link with two or more lanes as the one or more links.

7. The information processing apparatus according to claim 2, wherein the link that the vehicle driven by the driver has traveled is a road section in which no congestion has occurred during the vehicle's travel.

8. The information processing apparatus according to claim 2, wherein the link that the vehicle driven by the driver has traveled is a road section with two or more lanes.

9. The information processing apparatus according to claim 2, wherein
the driver's vehicle speed coefficient is a coefficient obtained for each type of links that the vehicle driven by the driver has traveled, and
the controller is configured to estimate the driver's vehicle speed for each link using, as the driver's vehicle speed coefficient, a coefficient according to a type of each link.

10. The information processing apparatus according to claim 2, wherein
the driver's vehicle speed coefficient is a coefficient obtained for each rank of congestion degree of the link that the vehicle driven by the driver has traveled, and
the controller is configured to estimate the driver's vehicle speed for each link using, as the driver's vehicle speed coefficient, a coefficient according to a rank of congestion degree of each link.

11. The information processing apparatus according to claim 10, wherein the congestion degree is an index represented by a ratio of traffic volume measured at each of the link that the vehicle driven by the driver has traveled and the multiple links, to traffic capacity set for a corresponding link.

12. The information processing apparatus according to claim 2, wherein
the driver's vehicle speed coefficient is a coefficient obtained for each number of lanes of links that the vehicle driven by the driver has traveled, and
the controller is configured to estimate the driver's vehicle speed for each link using, as the driver's vehicle speed coefficient, a coefficient according to a number of lanes of each link.

13. The information processing apparatus according to claim 2, wherein
the driver's vehicle speed coefficient is a coefficient obtained for each season in which the vehicle driven by the driver has traveled the link, and
the controller is configured to estimate the driver's vehicle speed for each link using, as the driver's vehicle speed coefficient, a coefficient for each link according to a season in which the driver plans to drive the vehicle.

14. The information processing apparatus according to claim 2, wherein
the driver's vehicle speed coefficient is a coefficient obtained for each weather condition in which the vehicle driven by the driver has traveled the link, and
the controller is configured to estimate the driver's vehicle speed for each link using, as the driver's vehicle speed coefficient, a coefficient for each link according to a weather condition in which the driver plans to drive the vehicle.

15. The information processing apparatus according to claim 2, wherein the controller is configured to estimate the driver's vehicle speed for each link by multiplying the driver's vehicle speed coefficient by a predetermined vehicle speed set for each link on the navigation application.

16. The information processing apparatus according to claim 2, wherein the driver's vehicle speed at the link that the vehicle driven by the driver has traveled and the driver's vehicle speed estimated for each link by the controller are each an average speed.

17. An information processing system comprising:
the information processing apparatus according to claim 2; and
a navigation apparatus on which the navigation application operates.

18. A vehicle comprising the information processing system according to claim 17.

19. A non-transitory computer readable medium storing a program configured to cause a computer to function as the information processing apparatus according to claim 2.

20. An information processing method performed by an information processing apparatus, the information processing method comprising:
acquiring a driver's vehicle speed coefficient obtained by dividing the driver's vehicle speed at a link that a vehicle driven by the driver has traveled, by a predetermined vehicle speed set for the link on a navigation application;
estimating, using the driver's vehicle speed coefficient, the driver's vehicle speed at each link, among multiple links included in a route to a destination along which the driver plans to drive the vehicle; and
calculating an expected arrival time at which the driver arrives at the destination, from a distance of each link and the driver's vehicle speed estimated for each link.
